(19) United States
(12) Patent Application Publication
(10) Pub. No.: US 2024/0240476 A1
(43) Pub. Date: Jul. 18, 2024

(54) SHIELDING DEVICE AND INSTALLATION METHOD THEREFOR

(71) Applicant: Kingwells Test Equipment Mfg., Ltd, Dongguan (CN)

(72) Inventor: Bing HE, Dongguan (CN)

(21) Appl. No.: 18/183,379

(22) Filed: Mar. 14, 2023

(30) Foreign Application Priority Data
Jan. 12, 2023 (CN) 202310066656.2

(51) Int. Cl. E04B 1/61; G10K 11/16

(52) U.S. Cl. CPC E04B 1/6116; G10K 11/16; E04B 2001/6195; E04H 1/125

(57) ABSTRACT

The present disclosure relates to a shielding device and an installation method thereof. The shielding device includes: a bottom plate; a first sidewall, a bottom end of the first sidewall being inserted into the bottom plate; a second sidewall, a bottom end of the second sidewall being inserted into the bottom plate; a top cover, the top cover having one side rotatably connected to the first sidewall and the other side inserted into the second sidewall; a front door connected to respective one ends of the bottom plate, the first sidewall, the second sidewall, and the top cover; and a rear plate connected to respective other ends of the bottom plate, the first sidewall, the second sidewall, and the top cover.

### CROSS REFERENCE TO RELATED APPLICATIONS

This application claims priority under 35 U.S.C. § 119 to Chinese Patent application Ser. No. 20/231,00666562, filed on Jan. 12, 2023, the entire content of which is incorporated herein in its entirety.

### TECHNICAL FIELD

The present disclosure relates to the field of building structure technologies, and in particular, to a shielding device and an installation method for a shielding device.

### BACKGROUND

A shielding device is generally used as a telephone booth, a mini singing room, a sound-proofing cabin, or the like, which may be arranged indoors and outdoors to provide users with places required for shelter, sound insulation, and the like. An existing shielding device is generally complex to assemble, and typically requires at least two persons to cooperate to complete, which leads to relatively high labor costs of installation.

### SUMMARY

Based on the above, there is a need to provide a shielding device that is easy to install and an installation method for a shielding device with respect to the problem of high labor costs of installation.

A shielding device, including:

a bottom plate;

a first sidewall, a bottom end of the first sidewall being inserted into the bottom plate;

a second sidewall, a bottom end of the second sidewall being inserted into the bottom plate;

a top cover, the top cover having one side rotatably connected to the first sidewall and the other side inserted into the second sidewall;

a front door connected to respective one ends of the bottom plate, the first sidewall, the second sidewall, and the top cover; and

a rear plate connected to respective other ends of the bottom plate, the first sidewall, the second sidewall, and the top cover.

A shielding device, including:

a bottom plate;

a first sidewall, an outer surface of the first sidewall being provided with an input terminal, and the first sidewall being connected to the bottom plate;

a second sidewall, the second sidewall being connected to the bottom plate;

a top cover, the top cover having one side rotatably connected to the first sidewall and the other side connected to the second sidewall, the top cover being provided with an electronic device, the electronic device being connected to the input terminal through a wire;

a front door connected to respective one ends of the bottom plate, the first sidewall, the second sidewall, and the top cover; and

a rear plate connected to respective other ends of the bottom plate, the first sidewall, the second sidewall, and the top cover.

An installation method for a shielding device, the method including:

causing a second sidewall to form pre-installation with one side of a bottom plate;

causing a first sidewall to form pre-installation with the other side of the bottom plate;

opening a top cover rotatably connected to the first sidewall and in a folded state to enable the top cover to form a connection with the second sidewall;

connecting a front door to one ends of the bottom plate, the top cover, the first sidewall, and the second sidewall; and

connecting a rear plate to the other ends of the bottom plate, the top cover, the first sidewall, and the second sidewall .

The above shielding device can be installed by a single person. Moreover, the electronic device and the input terminal that have formed an electrical connection can be pre-arranged in the top cover and the first sidewall rotatably connected to each other.

Therefore, there is no need to assemble electrical components during the installation, which can reduce qualification requirements for installers and save labor costs of installation.

### BRIEF DESCRIPTION OF THE DRAWINGS

FIG. 1 is a schematic diagram of a three-dimensional structure of a shielding device according to an embodiment of the present disclosure;

FIG. 2 is a three-dimensional exploded view of the shielding device shown in FIG. 1;

FIG. 3 is a schematic exploded and enlarged view of a partial structure of the shielding device shown in FIG. 2, which illustrates a partial structure of a bottom plate, a first sidewall, and a second sidewall of the shielding device;

FIG. 4 is a schematic enlarged view of a circle A in FIG. 3;

FIG. 5 is a schematic structural diagram of the bottom plate in the shielding device shown in FIG. 2;

FIG. 6 is a schematic enlarged view of a circle B in FIG. 5;

FIG. 7 is a schematic side view of the shielding device shown in FIG. 1, in which a partial structure is omitted and not shown;

FIG. 8 is a schematic sectional view taken along directions of arrows in FIG. 7;

FIG. 9 is a schematic enlarged view of a circle C in FIG. 8;

FIG. 10 is a schematic sectional view taken along directions of arrows in FIG. 8;

FIG. 11 is a schematic enlarged view of a circle D in FIG. 10;

FIG. 12 is a schematic exploded view of the first sidewall and a top cover in the shielding device shown in FIG. 2 from another perspective;

FIG. 13 is a schematic diagram of the first sidewall and the top cover in the shielding device shown in FIG. 2 in an unfolded state, in which a partial structure of the first sidewall is hidden to show an internal structure of the first sidewall;

FIG. 14 is a schematic diagram of the first sidewall and the top cover in the shielding device shown in FIG. 2 in a folded state, in which a partial structure of the first sidewall is hidden to show an internal structure of the first sidewall;

FIG. 15 is a schematic enlarged view of a circle E in FIG. 13;

FIG. 16 is a schematic enlarged view of a circle F in FIG. 14;

FIG. 17 is a schematic exploded and enlarged view of a partial structure of a shielding device according to an embodiment of the present disclosure, which illustrates a partial structure of a top cover, a first sidewall, and a second sidewall of the shielding device;

FIG. 18 is a schematic enlarged view of a circle G in FIG. 17;

FIG. 19 is a schematic exploded view of a front door of the shielding device according to an embodiment of the present disclosure;

FIG. 20 is a schematic enlarged view of a circle H in FIG. 19;

FIG. 21 is a schematic sectional view of a partial structure of the front door and the second sidewall of the shielding device according to an embodiment of the present disclosure;

FIG. 22 and FIG. 23 are schematic diagrams of a three-dimensional structure of a corner in the front door shown in FIG. 19 from different perspectives;

FIG. 24 and FIG. 25 are schematic three-dimensional exploded views of the corner in the front door shown in FIG. 19 from different perspectives; and

FIG. 26 to FIG. 28 are schematic structural diagrams of the front door and the second sidewall shown in FIG. 21 during assembly.

### DETAILED DESCRIPTION OF THE EMBODIMENTS

In order to make the above objectives, features and advantages of the present disclosure more obvious and understandable, specific implementations of the present disclosure are described in detail below with reference to the accompanying drawings. In the following description, many specific details are set forth in order to fully understand the present disclosure. However, the present disclosure can be implemented in many other ways different from those described herein, and those skilled in the art can make similar improvements without departing from the connotation of the present disclosure. Therefore, the present disclosure is not limited by specific embodiments disclosed below.

In the description of the present disclosure, it should be understood that the orientation or position relationships indicated by the terms “central”, “longitudinal”, “transverse”, “length”, “width”, “thickness”, “up”, “down”, “front”, “back”, “left”, “right”, “vertical”, “horizontal”, “top”, “bottom”, “inner”, “outer”, “clockwise”, “counterclockwise”, “axial”, “radial”, “circumferential”, etc. are based on the orientation or position relationships shown in the accompanying drawings and are intended to facilitate the description of the present disclosure and simplify the description only, rather than indicating or implying that the apparatus or element referred to must have a particular orientation or be constructed and operated in a particular orientation, and therefore are not to be interpreted as limiting the present disclosure.

In addition, the terms “first” and “second” are used for descriptive purposes only, which cannot be construed as indicating or implying a relative importance or implicitly specifying the number of the indicated technical features. Thus, the features defined with “first” and “second” may explicitly or implicitly include at least one feature. In the description of the present disclosure, “a plurality of” means at least two, such as two or three, unless specifically stated otherwise.

In the present disclosure, unless otherwise specifically stated and limited, the terms “install,” “join,” “connect”, “fix”, etc. should be understood in a broad sense, such as, a fixed connection, a detachable connection, or an integral connection; a mechanical connection, or an electrical connection; a direct connection, an indirect connection through an intermediate medium, internal communication between two elements, or an interaction of two elements, unless otherwise expressly defined. For those of ordinary skill in the art, the specific meanings of the foregoing terms in the present invention can be understood on a case-by-case basis.

In the present disclosure, unless otherwise explicitly specified and defined, a first feature being “on” or “under” a second feature may be a case that the first feature is in direct contact with the second feature, or the first feature is in indirect contact with the second feature via an intermediate medium. Furthermore, the first feature being “over”, “above” and “on top of” the second feature may be a case that the first feature is directly above or obliquely above the second feature, or only means that the level of the first feature is higher than that of the second feature. The first feature being “below”, “underneath” or “under” the second feature may be a case that the first feature is directly underneath or obliquely underneath the second feature, or only means that the level of the first feature is lower than that of the second feature.

It should be noted that when one element is referred to as “fixed to” or “arranged on” another element, it may be directly disposed on the other element or an intermediate element may exist. When one element is considered to be “connected to” another element, it may be directly connected to the other element or an intermediate element may co-exist. The terms “vertical”, “horizontal”, “up”, “down”, “left”, “right” and similar expressions used herein are for illustrative purposes only, and do not represent unique embodiments.

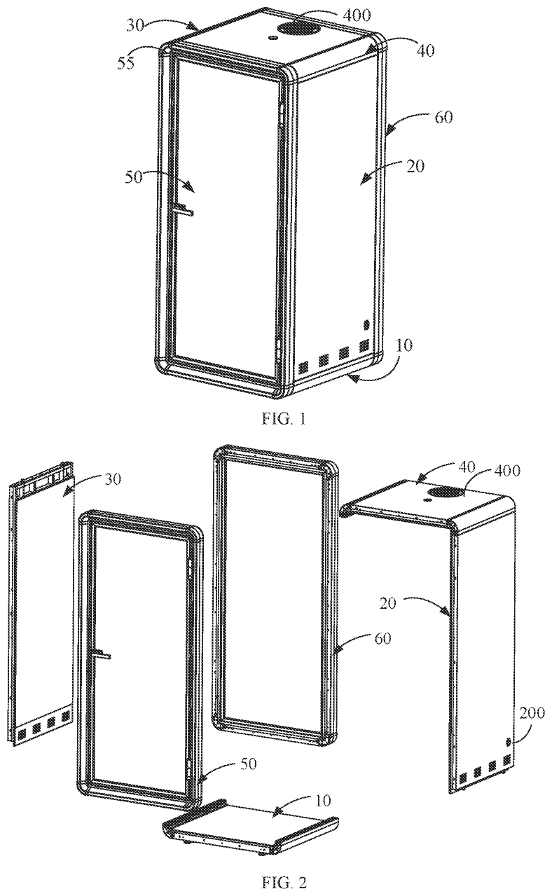

Referring to FIG. 1 and FIG. 2, FIG. 1 shows a three-dimensional structure of a shielding device according to an embodiment of the present disclosure, and FIG. 2 shows a breakdown structure of the shielding device according to an embodiment of the present disclosure. The shielding device in the embodiments includes a bottom plate 10, a first sidewall 20, a second sidewall 30, a top cover 40, a front door 50, and a rear plate 60. The bottom plate 10, the first sidewall 20, the second sidewall 30, the top cover 40, the front door 50, and the rear plate 60 are enclosed to form a roughly cuboid structure, and an internal space defined may be used as a place required by a user for shelter, sound insulation, or the like. The shielding device may form different functional devices according to a place where it is placed and functional devices arranged inside. For example, the shielding device may be placed in indoor places such as a shopping mall, an exhibition hall, and an office building, and used as a sound-proofing cabin for the user to conduct a meeting, make a call, and the like. The shielding device may also be placed in indoor and outdoor places such as a shopping mall, an exhibition hall, and a terrace, and used as a telephone booth, a singing room, and the like.

In the perspectives shown in FIG. 1 and FIG. 2, a bottom end of the first sidewall 20 is connected to a right side of the bottom plate 10, and a bottom end of the second sidewall 30 is connected to a left side of the bottom plate 10. A right side of the top cover 40 is rotatably connected to a top end of the first sidewall 20, and a left side of the top cover 40 is connected to a top end of the second sidewall 30. The front door 50 is connected to front ends of the bottom plate 10, the first sidewall 20, the second sidewall 30, and the top cover 40. The rear plate 60 is connected to rear ends of the bottom plate 10, the first sidewall 20, the second sidewall 30, and the top cover 40. The front door 50 is provided with a channel that can be opened or closed, and the user can enter and exit the shielding device from the channel of the front door 50.

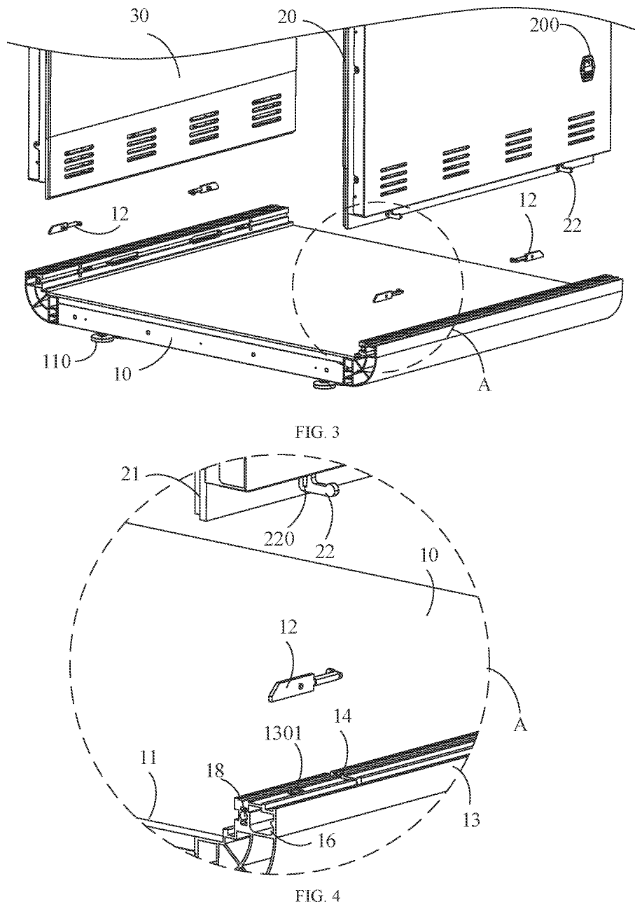

Further referring to FIG. 3 and FIG. 4, in an embodiment, the bottom end of the first sidewall 20 is inserted into the right side of the bottom plate 10. For example, the first sidewall 20 and the bottom plate 10 are provided with an insertion plate 22, an elastic bolt 12, and a slot 14 that fit one another. Further, the insertion plate 22 is provided with an insertion hole 220, and the elastic bolt 12 is at least partially exposed in the slot 14. After the insertion plate 22 extends into the slot 14, the elastic bolt 12 is first squeezed to produce elastic contraction to avoid the insertion plate 22, and then stretches into the insertion hole 220 of the insertion plate 22 due to elastic force, so as to complete the fit with the insertion plate 22. In this way, the insertion of the first sidewall 20 and the bottom plate 10 is realized.

In a specific embodiment, as shown in FIG. 3 and FIG. 4, the bottom plate 10 includes a base plate 11 and shoulders 13 arranged on left and right sides of the base plate 11. The base plate 11 is further provided with a plurality of legs 110 at the bottom. The legs 110 are configured to fix the shielding device to the ground.

The slot 14 and the elastic bolt 12 are both arranged on the bottom plate 10, more specifically on the shoulders 13. Since the two shoulders 13 are configured to be connected to the first sidewall 20 and the second sidewall 30 respectively, in an embodiment, structural arrangement on the two shoulders 13 may be the same. Therefore, the following description takes one shoulder 13 as an example, and the introduction of the other shoulder 13 is omitted unless otherwise specified.

At least part of the structure of the shoulder 13 is higher than the base plate 11, and the shoulder 13 has an arc-shaped outer contour, so that an overall section of the bottom plate 10 has an arc chamfer. The slot 14 and the elastic bolt 12 are arranged on a part of the shoulder 13 higher than the base plate 11, so that the installation of the first sidewall 20, the second sidewall 30, and the bottom plate 10 can be more convenient, which will be further described in the following description.

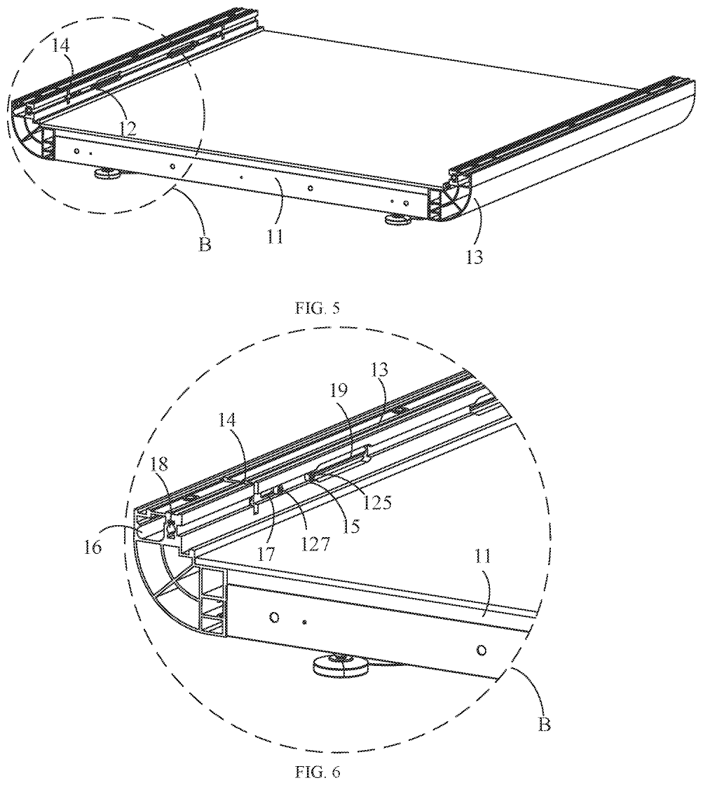

Referring to FIG. 5 and FIG. 6, the bottom plate 10 is provided therein with an abutment groove 16 and an installation groove 18. The abutment groove 16 is configured to fit a related structure on the insertion plate 22, and the installation groove 18 is configured to accommodate and install the elastic bolt 12. More specifically, both the abutment groove 16 and the installation groove 18 are arranged in the shoulder 13. The abutment groove 16 and the installation groove 18 are isolated from each other, and both extend through the shoulder 13 along a direction of front and rear ends of the shoulder 13. An extension direction of the slot 14 is perpendicular to that of the abutment groove 16 and the installation groove 18, which runs through and is communicated with the abutment groove 16 and the installation groove 18. Numbers of the slot 14 and the elastic bolt 12 spaced apart in the direction of the front and rear ends of the shoulder 13 may be more than one, for example, two, three, or the like. It may be understood that a number of the insertion plate 22 is the same.

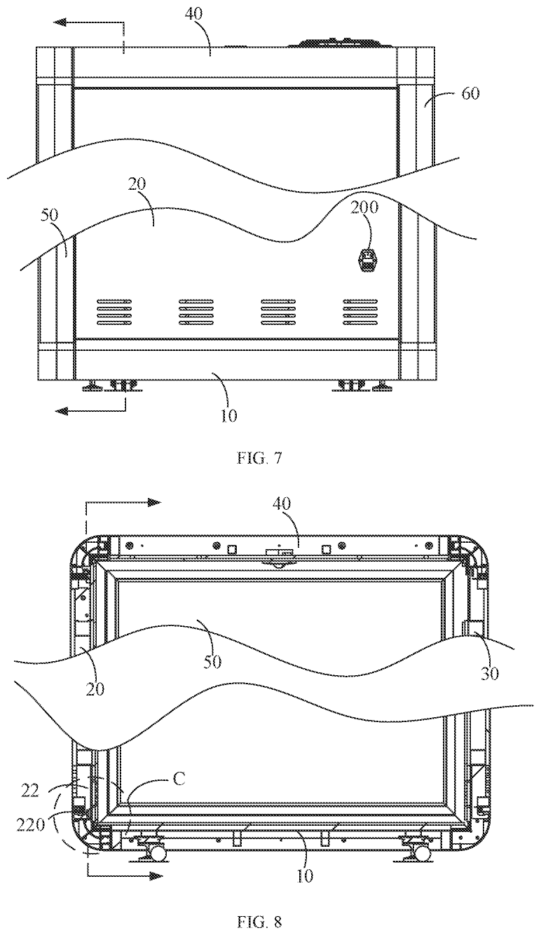

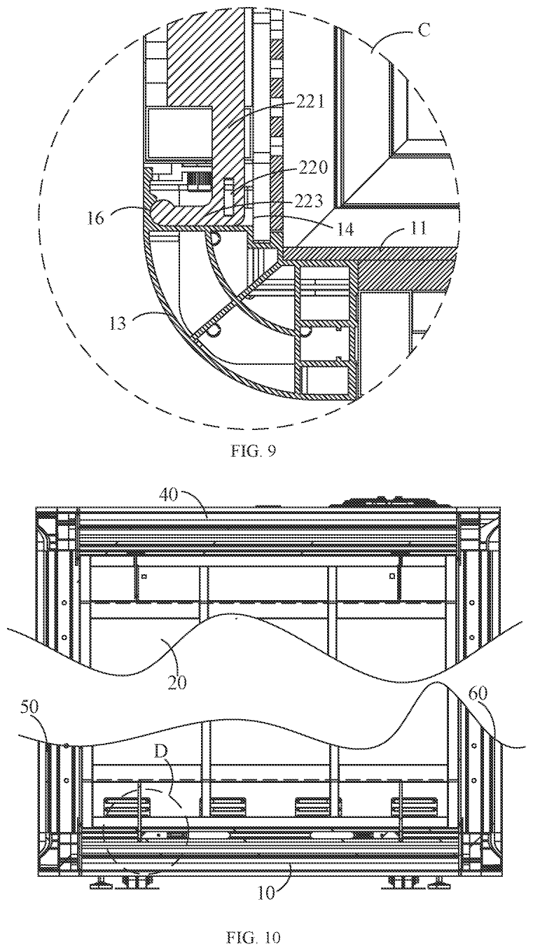

Still referring to FIG. 4, the first sidewall 20 includes a plate body 21, and the insertion plate 22 extends from the plate body 21. As shown in FIG. 7, FIG. 8, and FIG. 9, the insertion plate 22 includes a vertical section 221 extending from the plate body 21 and a horizontal section 223 extending horizontally from the vertical section 221. A tail end of the horizontal section 223 has a cambered configuration. The tail end of the horizontal section 223 has a same cambered structure as a groove wall of the abutment groove 16, so that the tail end of the horizontal section 223 can form running fit with the abutment groove 16 when reaching the abutment groove 16. The running fit is limited by a bottom wall of the abutment groove 16, as shown in FIG. 9. The horizontal section 223, that is, the first sidewall 20, can rotate counterclockwise around the abutment groove 16.

In the installation of the shielding device, the first sidewall 20 may be horizontally placed and transported by using a tool cart, so that the first sidewall 20 is at a position slightly higher than the bottom plate 10 and approaches the bottom plate 10. When the insertion plate 22 is located above the slot 14 of the bottom plate 10, the top end of the first sidewall 20 may be lifted, so that the insertion plate 22 extends into the slot 14 from top to bottom, and the tail end of the horizontal section 223 of the insertion plate 22 forms running fit with the abutment groove 16 until the first sidewall 20 is turned from horizontal to vertical, forming an assembled state as shown in FIG. 9. During the turning, the insertion plate 22 squeezes the elastic bolt 12 exposed in the slot 14, so that the elastic bolt 12 contracts first and then extends into the insertion hole 220 of the insertion plate 22 to complete the fit with the board 22. So far, pre-installation of the first sidewall 20 and the bottom plate 10 has been completed. In order to make the pre-installed first sidewall 20 still have a certain rotation range around the bottom plate 10 and to facilitate subsequent installation of the top cover 40 and the first sidewall 20, fit clearance between the insertion hole 220 and the insertion plate 22 can be reserved to a set size. As shown in FIG. 9, the insertion hole 220 is at least partially formed in the vertical section 221. In this way, the insertion hole 220 has a predetermined distance from the tail end of the horizontal section 223, and a pre-installation effect and the reserved rotation range of the first sidewall 20 and the bottom plate 10 can also be guaranteed.

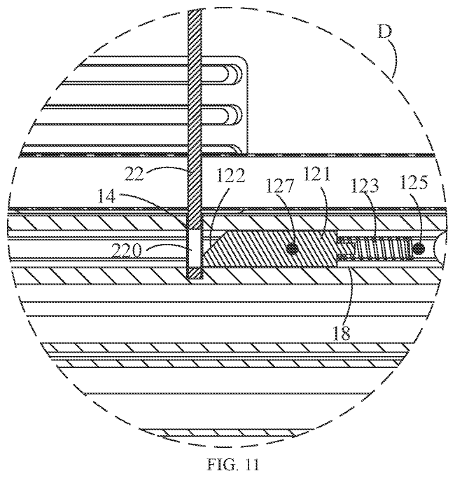

Referring to FIG. 10 and FIG. 11, in an embodiment, the elastic bolt 12 includes a bolt rod 121 and an elastic member 123. The elastic member 123 is connected between one end of the bolt rod 121 and the bottom plate 10, the other end of the bolt rod 121 is provided with a guide surface 122, and the guide surface 122 is at least partially exposed in the slot 14. When the insertion plate 22 extends into the slot 14, the insertion plate 22 may squeeze the guide surface 122, thereby causing the bolt rod 121 to be stressed and compress the elastic member 123. After the insertion plate 22 crosses the guide surface 122 and makes the insertion hole 220 on the insertion plate 22 aligned with the bolt rod 121, the bolt rod 121 can extend into the insertion hole 220 due to elastic force produced by the compression of the elastic member 123 to complete the fit with the insertion hole 220.

Referring to FIG. 4, FIG. 6, and FIG. 11 together, in some embodiments, the elastic bolt 12 further includes a fixed handle 125 and a limit handle 127. The fixed handle 125 is connected to the elastic member 123. The limit handle 127 is connected to the bolt rod 121. The bottom plate 10 is provided with a fixed groove 15 and a limit groove 17. More specifically, the shoulder 13 is provided with the fixed groove 15 and the limit groove 17. The limit groove 17 extends along the direction of the front and rear ends of the shoulder 13 with a certain length, and the length is set to a moving length of the elastic bolt 12. The fixed handle 125 fixedly passes through the fixed groove 15, so that one end of the elastic member 123 is fixed to the bottom plate 10. The limit handle 127 is movably arranged through the limit groove 17, and when the bolt rod 121 is squeezed by the insertion plate 22, the limit handle 127 moves in the limit groove 17.

Further, as shown in FIG. 6, in some embodiments, the bottom plate 10 is further provided with a hollow groove 19. More specifically, the hollow groove 19 is arranged on the shoulder 13. The slot 14, the limit groove 17, the fixed groove 15, and the hollow groove 19 are successively spaced apart and are all communicated with the installation groove 18. In the installation of the elastic bolt 12, the bolt rod 121 and the elastic member 123 can extend into the installation groove 18 from the hollow groove 19, and then the fixed handle 125 passes through the fixed groove 15 from the outside of the shoulder 13 to be connected to the elastic member 123, and the limit handle 127 passes through the limit groove 17 from the outside of the shoulder 13 to be connected with the bolt rod 121.

As shown in FIG. 3, in an embodiment, the bottom end of the second sidewall 30 is inserted into the left side of the bottom plate 10. A specific insertion fitting structure and method may be the same as the above fitting structure and method of the first sidewall 20 and the bottom plate 10. Details are not described.

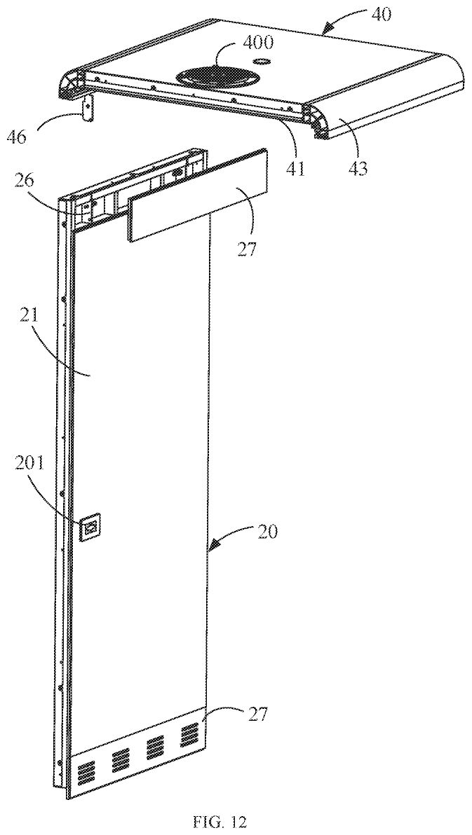

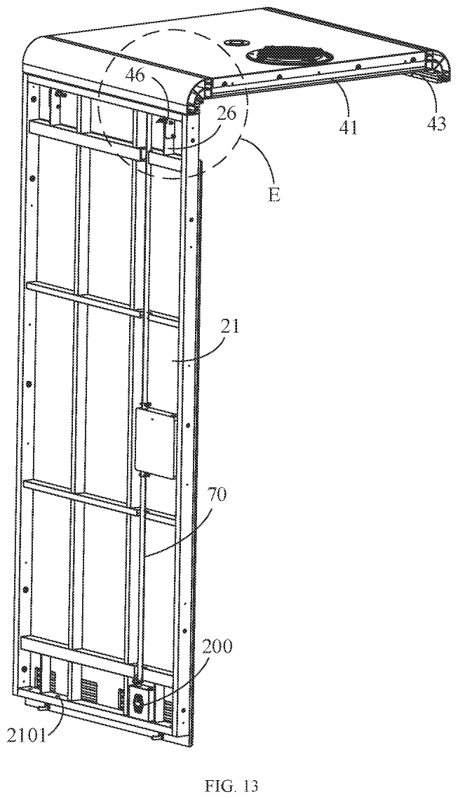

FIG. 12 shows a breakdown structure of the top cover 40 and the first sidewall 20, from a perspective different from that in FIG. 2. In FIG. 2, the right side of the top cover 40 is rotatably connected to the top end of the first sidewall 20. Due to a change in the perspective in FIG. 12, it appears that the left side of the top cover 40 is rotatably connected to the top end of the first sidewall 20. Perspectives in FIG. 13 to FIG. 16 are roughly the same as that in FIG. 12. In order to prevent difficulty in understanding, specific “left side” or “right side” is avoided in the following description.

As shown in FIG. 12, the top cover 40 includes a cover plate 41 and bending portions 43 arranged on two sides of the cover plate 41 and extending downwards. The bending portions 43 have cambered outer contours, so that an overall section of the top cover 40 has an arc chamfer. The top cover 40 is provided with an electronic device 400. The electronic device 400 may be specifically arranged on the cover plate 41. The electronic device 400 may be one or more of a fan, a lamp, a speaker, and a camera. One side of the top cover 40 extends to form a connecting plate 46. The connecting plate 46 is configured to form a rotatable connection with the first sidewall 20. Specifically, the connecting plate 46 extends downwards from the bottom of the bending portion 43.

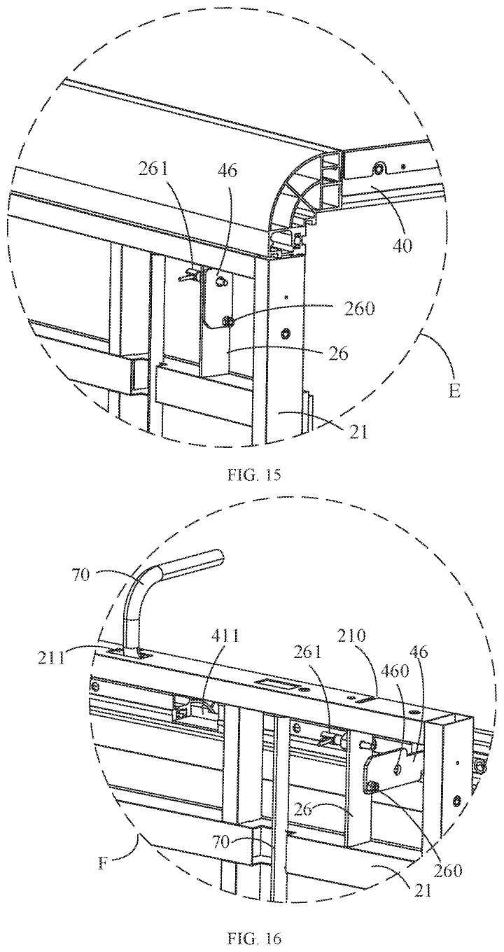

The first sidewall 20 includes the above plate body 21 and a fixed plate 26 formed on the plate body 21. As shown in FIG. 15 and FIG. 16, the fixed plate 26 and the connecting plate 46 are rotatably connected through a rotating shaft 260, so as to realize the rotatable connection between the first sidewall 20 and the top cover 40. FIG. 15 shows that the first sidewall 20 and the top cover 40 are unfolded and restricted from rotating, and FIG. 16 shows that the first sidewall 20 and the top cover 40 are folded and relatively rotatable. The fixed plate 26 is provided with an elastic pin 261, and the connecting plate 46 is provided with a lock hole 460 configured to fit the elastic pin 261. When the top cover 40 along with the connecting plate 46 is rotated relative to the first sidewall 20 from the folded state shown in FIG. 16 to the unfolded state shown in FIG. 15, the elastic pin 261 may be toggled to enable the elastic pin 261 to be inserted into the lock hole 460, and then the first sidewall 10 and the top cover 40 are restricted from rotating.

Further, the plate body 21 is provided with an accommodating groove 210, and when the elastic pin 261 is inserted into the lock hole 460, the connecting plate 46 is at least partially arranged in the accommodating groove 210. The accommodating groove 210 is configured to provide an avoidance space for the top cover 40 to rotate relative to the first sidewall 20 to avoid interference of related components. It may be understood that, in the folded state, the related components on the first sidewall 20 may be disassembled first to avoid interference. For example, as shown in FIG. 12, the top of the first sidewall 20 is provided with a decorative plate 27, and the decorative plate 27 covers components on the plate body 21 such as the plate body 21 and the fixed plate 26, the rotating shaft 260, and the elastic pin 261. When there is a need to fold the top cover 40 and the first sidewall 20, the decorative plate 27 is first removed to provide a suitable space for the rotation of the connecting plate 46. After the top cover 40 and the first sidewall 20 are installed and in the unfolded state, the decorative plate 27 is installed on the plate body 21. The decorative plate 27 and the plate body 21 may be connected by velcro. For example, a hook surface and a velvet surface of the velcro are arranged on respective butting surfaces of the decorative plate 27 and the plate body 21, and then the decorative plate 27 and the plate body 21 are bonded. In this connection manner, no assembly marks may be left on the inner side of the first sidewall 20, making the shielding device more beautiful. Similarly, another decorative plate 27 may also be arranged at the bottom of the first sidewall 20. When the first sidewall 20 and the bottom plate 10 are pre-installed, the decorative plate 27 at the bottom is also removed first, and after the pre-installation of the first sidewall 20 and the bottom plate and further fastening installation, the decorative plate 27 at the bottom is installed, which will be further introduced below. The manner in which the decorative plate 27 at the bottom is connected to the plate body 21 may be the same as the manner in which the decorative plate 27 at the top is connected to the plate body 21. Details are not described.

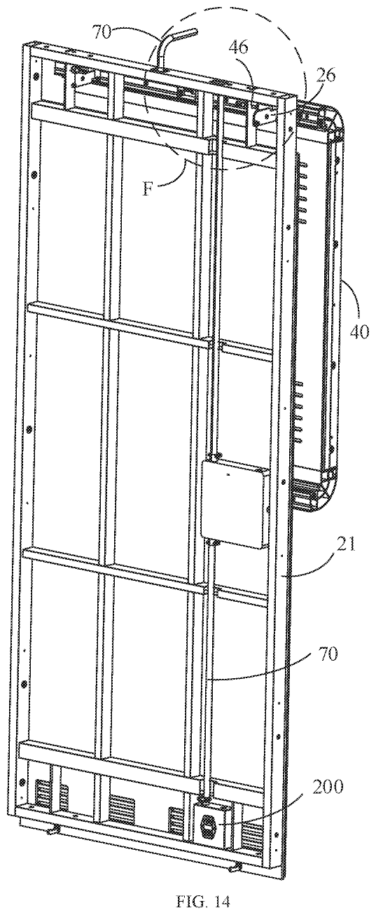

As shown in FIG. 13 and FIG. 14, an outer surface of the first sidewall 20 is provided with an input terminal 200, and the input terminal 200 is connected with the electronic device 400 through a wire 70. The input terminal 200 may be connected to mains to provide electric energy for the electronic device 400 to operate. As shown in FIG. 16, appropriate channels 211 and 411 are arranged on the first sidewall 20 and the top cover 40, so that the wire 70 can be routed therein. The first sidewall 20 is rotatably connected to the top cover 40, and the input terminal 200 is pre-arranged in the first sidewall 20. The electronic device 400 is pre-arranged in the top cover 40 and forms an electrical connection with the input terminal 200, so that there is no need to assemble electrical components during the installation of the shielding device, which can reduce qualification requirements for installers and save labor costs of installation.

As shown in FIG. 12, an inner surface of the first sidewall 20 is provided with an output terminal 201, and the output terminal 201 is electrically connected with the input terminal 200. The output terminal 201 may allow the user to connect other electrical devices, such as a mobile phone, a computer, and so on.

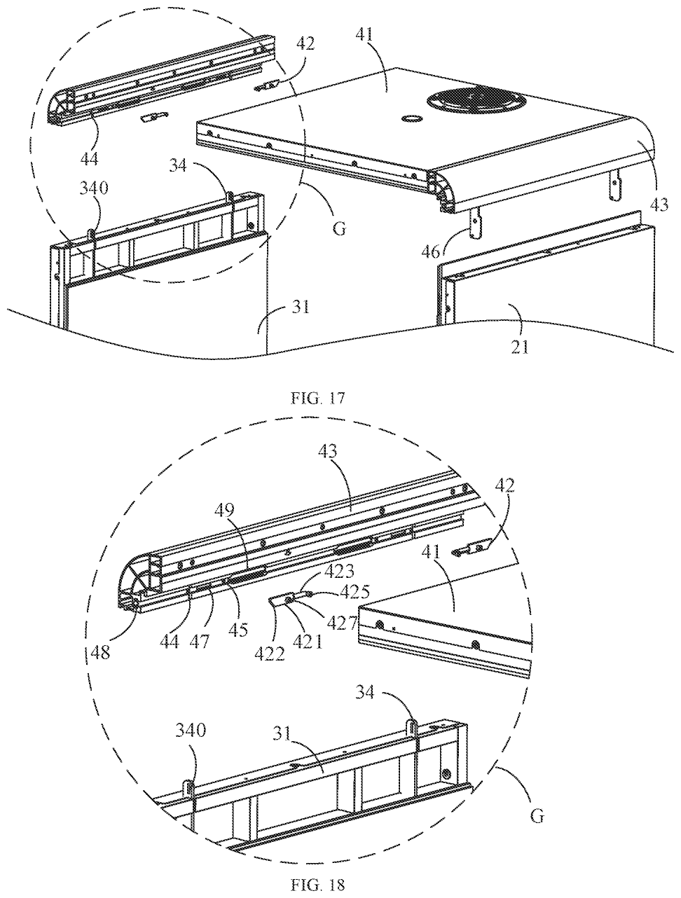

Further referring to FIG. 17 and FIG. 18, in an embodiment, one side of the top cover 40 away from the first sidewall 20 is inserted into the top end of the second sidewall 30. For example, the second sidewall 30 and the top cover 40 are provided with an insertion plate 34, an elastic bolt 42, and a slot 44 that fit one another. Further, the insertion plate 34 is provided with an insertion hole 340, and the elastic bolt 42 is at least partially exposed in the slot 44. After the insertion plate 34 extends into the slot 44, the elastic bolt 42 is first squeezed to produce elastic contraction to avoid the insertion plate 34, and then stretches into the insertion hole 340 of the insertion plate 34 due to elastic force, so as to complete the fit with the insertion plate 34. In this way, the insertion of the second sidewall 30 and the top cover 40 is realized.

As shown in FIG. 17 and FIG. 18, in a specific embodiment, the slot 44 and the elastic bolt 42 are both arranged on the top cover 40, more specifically on the bending portion 43 configured to be connected to the second sidewall 30. The top cover 40 is provided therein with an installation groove 48. More specifically, the installation groove 48 is arranged on the bending portion 43 configured to be connected to the second sidewall 30. The installation groove 48 is configured to accommodate and install the elastic bolt 42. The installation groove 48 extends through the bending portion 43 along a direction of front and rear ends of the bending portion 43. An extension direction of the slot 44 is perpendicular to that of the installation groove 48, which is communicated with the installation groove 48. Numbers of the slot 44 and the elastic bolt 42 spaced apart in the direction of the front and rear ends of the bending portion 43 may be more than one, for example, two, three, or the like. It may be understood that a number of the insertion plate 34 is the same.

As shown in FIG. 18, the second sidewall 30 includes a plate body 31, and the insertion plate 34 extends from the plate body 31. After the pre-installation of the first sidewall 20 and the bottom plate 10 and the pre-installation of the second sidewall 30 and the bottom plate 10, the top cover 40 in the folded state can be rotated relative to the first sidewall 20 to the unfolded state. In the pre-installed state, both the first sidewall 20 and the second sidewall 30 have a certain degree of freedom of rotation and deflection relative to the bottom plate 10. Therefore, the top cover 40 can pass from bottom to top and reach above the top end of the second sidewall 30 when unfolded. Then, the top cover 40 rotates from top to bottom and is aligned with the second sidewall 30 to enable the insertion plate 34 on the second sidewall 30 to extend into the slot 44 of the top cover 40. In this process, the insertion plate 34 squeezes the elastic bolt 42 exposed in the slot 44, so that the elastic bolt 42 contracts first and then extends into the insertion hole 340 of the insertion plate 34 to complete the fit with the board 34, so as to complete the connection between the top cover 40 and the second sidewall 30.

Still referring to FIG. 18, in an embodiment, the elastic bolt 42 includes a bolt rod 421 and an elastic member 423. The elastic member 423 is connected between one end of the bolt rod 421 and the top cover 40, the other end of the bolt rod 421 is provided with a guide surface 422, and the guide surface 422 is at least partially exposed in the slot 44. When the insertion plate 34 extends into the slot 44, the insertion plate 34 may squeeze the guide surface 422, thereby causing the bolt rod 421 to be stressed and compress the elastic member 423. After the insertion plate 34 crosses the guide surface 423 and makes the insertion hole 340 on the insertion plate 34 aligned with the bolt rod 421, the bolt rod 421 can extend into the insertion hole 340 due to elastic force produced by the compression of the elastic member 423 to complete the fit with the insertion hole 340.

As shown in FIG. 18, in some embodiments, the elastic bolt 42 further includes a fixed handle 425 and a limit handle 427. The fixed handle 425 is connected to the elastic member 423. The limit handle 427 is connected to the bolt rod 421. The top cover 40, more specifically, the bending portion 43 connected to the second sidewall 30, is provided with a fixed groove 45 and a limit groove 47. The limit groove 47 extends along the direction of the front and rear ends of the bending portion 43 with a certain length, and the length is set to a moving length of the elastic bolt 42. The fixed handle 425 fixedly passes through the fixed groove 45, so that one end of the elastic member 423 is fixed to the top cover 40. The limit handle 427 is movably arranged through the limit groove 47, and when the bolt rod 421 is squeezed by the insertion plate 34, the limit handle 427 moves in the limit groove 47.

Further, as shown in FIG. 18, in some embodiments, the top cover 40, specifically the bending portion 43 connected to the second sidewall 30, is further provided with a hollow groove 49. The slot 44, the limit groove 47, the fixed groove 45, and the hollow groove 49 are successively spaced apart and are all communicated with the installation groove 48. In the installation of the elastic bolt 42, the bolt rod 421 and the elastic member 423 can extend into the installation groove 48 from the hollow groove 49, and then the fixed handle 425 passes through the fixed groove 45 from the outside of the bending portion 43 to be connected to the elastic member 423, and the limit handle 427 passes through the limit groove 47 from the outside of the bending portion 43 to be connected with the bolt rod 421.

As shown in FIG. 13, a fastening hole 2101 may be formed on the plate body 21 of the first sidewall 20. As shown in FIG. 4, a fastening hole 1301 is formed on the shoulder 13 of the bottom plate 10. The pre-installed bottom plate 10 and first sidewall 20 are further reinforced by threading a fastener through the fastening holes 1301 and 2101. It may be understood that the second sidewall 30 and the bottom plate 10 as well as the second sidewall 30 and the top cover 40 may be designed similarly. Details are not described.

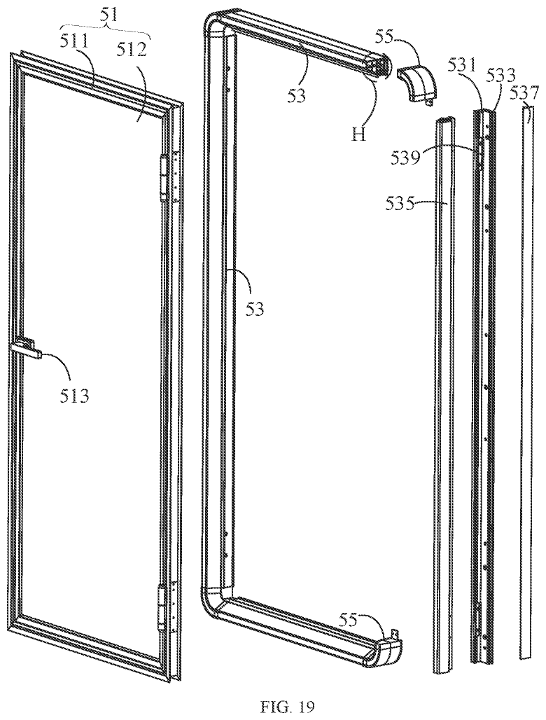

As shown in FIG. 19, in an embodiment, the front door 50 includes a door panel 51, a plurality of frames 53, and a plurality of corners 55. Each of the frames 53 is arranged on a corresponding side of the door panel 51, and each of the corners 55 is arranged at a corresponding corner of the door panel 51 and connected between two adjacent frames 53. In this embodiment, the door panel 51 is quadrilateral, so four frames 53 and four corners 55 are provided. Since the door panel 51 has a long side and a short side, the frames 53 also have long and short specifications, and composition structures of the frames 53 of the two specifications are the same. It may be understood that, in other embodiments, if the shape of the door panel 51 changes, numbers of the frames 53 and the corners 55 should also be adjusted adaptively. For example, if the door panel 51 is hexagonal, both the numbers of the frames 53 and the corners 55 are also six.

In an embodiment, the door panel 51 includes a door frame 511 and a door leaf 512 that is arranged in the door frame 511 and forms a rotatable connection with the door frame 511. The door leaf 512 is further provided with a door handle 513, and the user may open or close the door leaf 512 relative to the door frame 511 by operating the door handle 513. When the door leaf 512 is relatively opened, a channel for the user to enter and exit the shielding device may be formed.

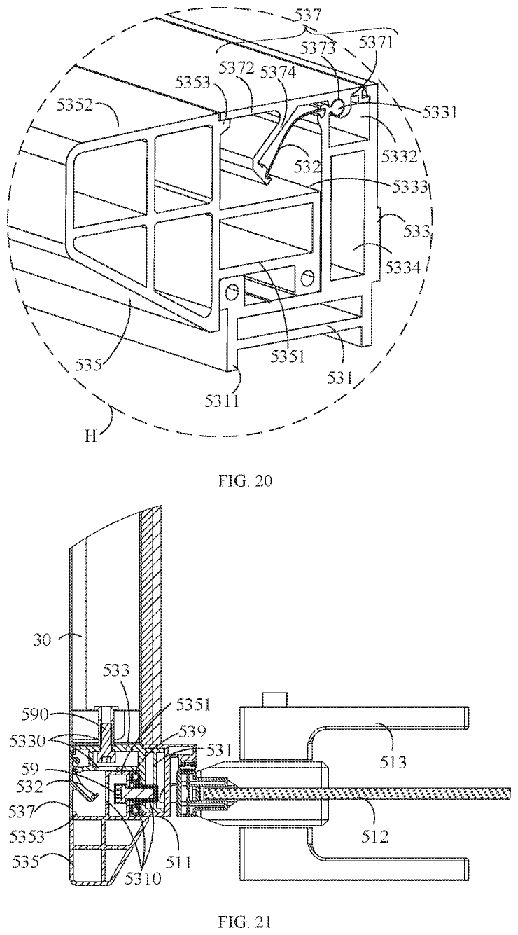

Referring to FIG. 20 and FIG. 21 together, in an embodiment, each of the frames 53 includes a convex edge 531, a wing edge 533, an outer edge 535, and a wrapping edge 537.

The convex edge 531 is connected to a corresponding side of the door panel 51. Widths of junctions between the convex edges 531 and the door panels 51 are approximately equal. The connection manner may be clamping, screwing, welding, or a combination thereof. In the structures shown in FIG. 20 and FIG. 21, the convex edge 531 extends toward the door frame 511 of the door panel 51 to form a clamping portion 5311, and the clamping portion 5311 is clamped in the door frame 511. It may be understood that further welding may be performed on the basis of the clamping.

The wing edge 533 is connected to the convex edge 531 and is generally in an L-shaped configuration. The L-shaped configuration makes the wing edge 533 and the convex edge 531 enclosed to form an avoiding groove 5333, which may be configured to accommodate part of a structure of the outer edge 535 and part of a structure of the wrapping edge 537. The wing edges 533 are correspondingly connected to respective one ends of the bottom plate 10, the first sidewall 20, the second sidewall 30, and the top cover 40. Specifically, in an embodiment where four frames 53 are provided, the wing edge 533 in the first frame 53 is connected to a front end of the bottom plate 10, the wing edge 533 in the second frame 53 is connected to a front end of the first sidewall 20, the wing edge 533 in the third frame 53 is connected to a front end of the second sidewall 30, and the wing edge 533 in the fourth frame 53 is connected to a front end of the top cover 40. As shown in FIG. 21, fastening holes 5330 may be formed on both the front end of the second sidewall 30 and the wing edge 533, and then the wing edges 533 are fastened and connected to the front end of the second sidewall 30 by threading the fastener 590 through the fastening holes 5330. Manners in which other wing edges 533 are connected to the front ends of the bottom plate 10, the first sidewall 20, and the top cover 40 may be obtained with reference to the above embodiment. Details are not described. The following will also take the connection between the wing edge 533 and the front end of the second sidewall 30 as an example for further introduction. Unless otherwise specified, other wing edges 533 are connected to the front ends of the bottom plate 10, the first sidewall 20, and the top cover 40 in a same manner, and corresponding descriptions are omitted.

The outer edge 535 is rotatably connected to the convex edge 531. More specifically, the outer edge 535 is rotatably connected to an outside edge of the convex edge 531. The outside edge may be understood as one side of the convex edge 531 away from the wing edge 533. Further, the outer edge 535 extends beyond an outside edge of the convex edge 531. As shown in FIG. 20, the outer edge 535 includes a rotary connecting portion 5351 and a decorative portion 5352 connected to each other, and the rotary connecting portion 5351 is rotatably connected to the outside edge of the convex edge 531. In the assembled state as shown in FIG. 20 and FIG. 21, the decorative portion 5352 extends beyond the outside edge of the convex edge 531. The decorative portion 5352 has a cross section gradually decreasing in a direction away from the convex edge 531. Alternatively, the decorative portion 5352 has a cross section gradually decreasing in a direction away from the wing edge 533. The configuration of the decorative portion 5352 enables the channel for entering and exiting the shielding device formed by the front door 50 to have an open shape.

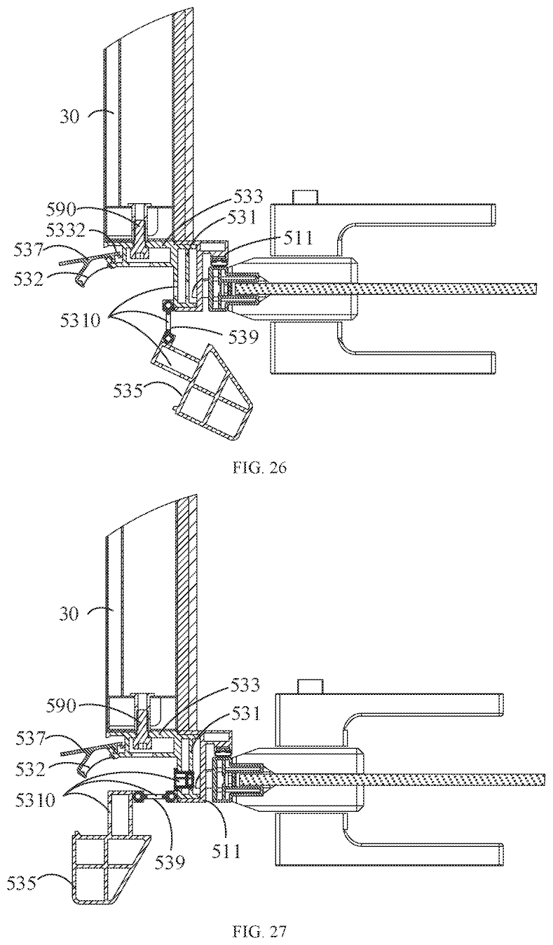

Referring to FIG. 26 together, the outer edge 535 is rotatably connected to the convex edge 531, so that the outer edge 535 can rotate relative to the convex edge 531 to expose the wing edge 533 during the installation, and the fastener 590 can pass through the wing edge 533 and the front end of the second sidewall 30 to complete the fixed connection with the second sidewall 30.

Further, as shown in FIG. 19 and FIG. 21, the frame 53 further includes an adapter plate 539. One end of the adapter plate 539 is rotatably connected to the outside edge of the convex edge 531, and the other end of the adapter plate 539 is rotatably connected to one end of the rotary connecting portion 5351 away from the decorative portion 5352. With the arrangement of the adapter plate 539, a rotation range of the outer edge 535 relative to the convex edge 531 may be larger. As shown in FIG. 26, the rotation angle may be greater than 180 degrees or even greater, such as greater than 360 degrees. Therefore, during the installation, interference of the outer edge 535 with the wing edge 533 can be better prevented, facilitating fixed installation of the wing edge 533 and the front end of the second sidewall 30.

As shown in FIG. 21, fastening holes 5310 are provided on all the rotary connecting portion 5351, the adapter plate 539, and the convex edge 531. The outer edge 535 can be fixed relative to the convex edge 531 by using the fastener 59 to sequentially pass through the fastening holes 5310 on the rotary connecting portion 5351, the adapter plate 539, and the convex edge 531. As can be seen from FIG. 20 and FIG. 21, both the rotary connecting portion 5351 of the outer edge 535 and the adapter plate 539 are accommodated in the avoiding groove 5333 formed by the wing edge 533 and the convex edge 531.

The wrapping edge 537 is rotatably connected to the wing edge 533 and joins the outer edge 535. As shown in FIG. 20, the wrapping edge 537 and the wing edge 533 are provided with a flange 5331 and a recess 5373 in running fit with each other. More specifically, the wrapping edge 537 includes a pressing portion 5371, a buckle portion 5372, and an abutting portion 5374, the recess 5373 is arranged at a junction between the pressing portion 5371 and the buckle portion 5372, and the abutting portion 5374 extends from the buckle portion 5372 and is accommodated in the avoiding groove 5333. The flange 5331 is formed on one end of the wing edge 533 away from the convex edge 531. The outer edge 535 is provided with a lap 5353, and a tail end of the buckle portion 5372 is joined on the lap 5353. As shown in FIG. 21, surfaces of the wrapping edge 537, the outer edge 535, and the second sidewall 30 are flush. It may be understood that a similar feature also exists when the frame 53 fits the corresponding bottom plate 10, the first sidewall 20, and the top cover 40.

As shown in FIG. 20, a pressing groove 5332 is further formed on the end of the wing edge 533 away from the convex edge 531. Referring to FIG. 26 together, the pressing portion 5371 is operated so that the pressing portion 5371 is rotated and accommodated in the pressing groove 5332. At the same time, the abutting portion 5374 is located outside the avoiding groove 5333, and the buckle portion 5372 is separated from the outer edge 535, so the outer edge 535 can rotate relative to the convex edge 531, thereby exposing the wing edge 533.

Further, as shown in FIG. 20, in some embodiments, the frame 53 further includes an assisting member 532, and the assisting member 532 is elastically arranged between the abutting portion 5374 and the flange 5331. The assisting member 532 may provide elastic support for keeping the wrapping edge 537 in a corresponding state, so as to prevent arbitrary movement of the wrapping edge 537. For example, in the state shown in FIG. 20, the assisting member 532 enables the wrapping edge 537 to be stably joined on the outer edge 535. In the state shown in FIG. 26, the assisting member 532 enables the pressing portion 5371 of the wrapping edge 537 to be stably accommodated in the pressing groove 5332 and the buckle portion 5372 and the abutting portion 5374 of the wrapping edge 537 to be stably located outside the avoiding groove 5333, thereby ensuring that the wrapping edge 537 and the outer edge 535 are in a stable separation state.

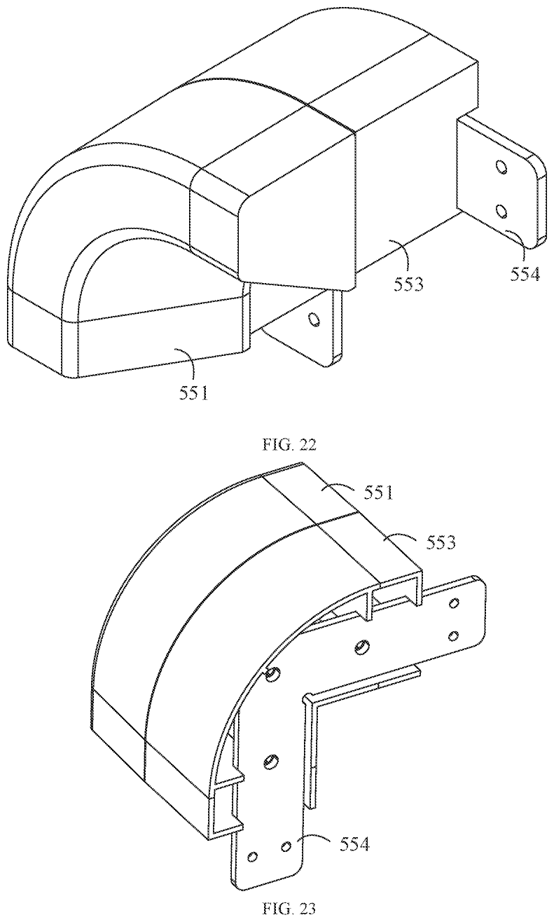

Referring to FIG. 22 to FIG. 25 together, the corner 55 includes a first ornament 551, a first connecting piece 552, a second ornament 553, and a second connecting piece 554 connected in sequence. Referring to FIG. 1 together, the first ornament 551, the first connecting piece 552, the second ornament 553, and the second connecting piece 554 are sequentially arranged in a direction from front ends to rear ends, and are aligned with the arc chamfers of the bottom plate 10 and the top cover 40. Contours of the first ornament 551 and the second ornament 553 are both cambered, and match the arc chamfers of the bottom plate 10 and the top cover 40, so that the shielding device has an integral and continuous outer contour surface at each corner.

Referring to FIG. 19, FIG. 20, and FIG. 22 together, a cross-sectional outer contour of the first ornament 551 matches a cross-sectional outer contour of the decorative portion 5352 of the outer edge 535, and a cross-sectional outer contour of the second ornament 553 matches a cross-sectional outer contour of a combination formed by the rotary connecting portion 5351 of the outer edge 535, the convex edge 531, the wing edge 533, and the wrapping edge 537. Therefore, a frame structure formed by the frame 53 and the corner 55 has a substantially constant contour and size in a circumferential direction.

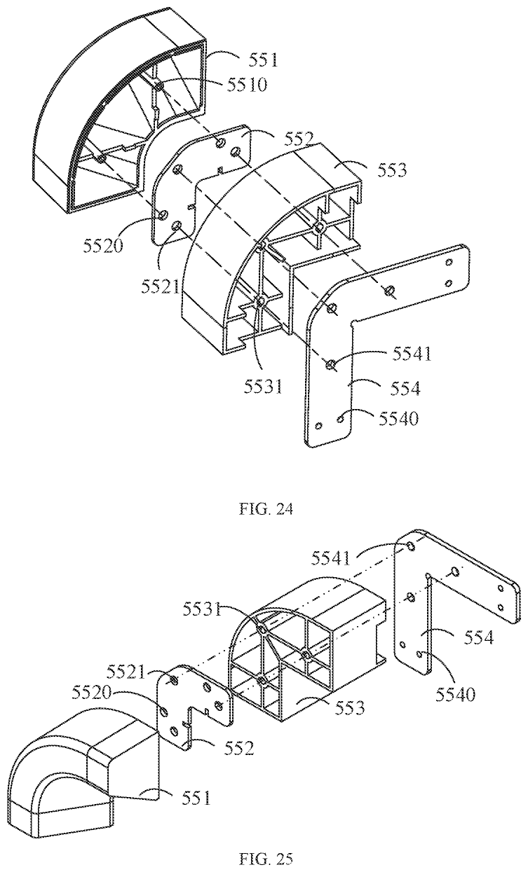

As shown in FIG. 24 and FIG. 25, a pin shaft 5510 extends from a surface where the first ornament 551 is connected to the first connecting piece 552, and a corresponding pin hole 5520 is formed in the first connecting piece 552. After the pin shaft 5510 is inserted into the pin hole 5520, the first ornament 551 and the first connecting piece 552 can be fixedly connected.

Further, all the first connecting piece, the second ornament 553, and the second connecting piece 554 are provided with corresponding connecting holes 5521, 5531, and 5541, and the first connecting piece, the second ornament 553, and the second connecting piece 554 can be fixedly connected by threading a fastener such as a screw through the connecting holes 5521, 5531, and 5541. After the fixed connection of the first ornament 551, the first connecting piece 552, the second ornament 553, and the second connecting piece 554, the first connecting piece 552 is wrapped by the first ornament 551 and the second ornament 553, and two ends of the second connecting piece 554 extend beyond the second ornament 553. As shown in FIG. 20, a connecting groove 5334 is also formed on the wing edge 533. When the corner 55 is connected between two adjacent frames 53, the two ends of the second connecting piece 554 exposed outside the second trim 553 extend into the connecting groove 5534 of the wing edge 533 of the two adjacent frames 53. Optionally, connecting holes 5540 may also be formed on the two ends of the second connecting piece 554. The corner 55 and the frames 53 can be further stably connected by threading the fastener such as a screw through the wing edge 533 and the connecting holes 5540.

In some embodiments, the rear plate 60 may have a same structure as the front door 50 introduced in any of the above embodiments. Details are not described. When the rear plate 60 has a same structure as the front door 50, both front and rear ends of the shielding device have channels for the user to enter and exit the shielding device. In some other embodiments, as shown in FIG. 2, the door panel of the rear plate 60 may not be provided with a door leaf that can be opened and closed. That is, the door panel is a whole plate-like structure that cannot be opened. In this embodiment, the channel for the user to enter and exit the shielding device is provided on the front end of the shielding device.

The present disclosure further provides an installation method for a shielding device. The installation method for a shielding device may be applied to installation of the shielding device in any of the above embodiments. The installation method for a shielding device is intended to provide guidance for the user to transform the shielding device shown in FIG. 2, which basically has five separate large components, into a shielding device having the form shown in FIG. 1. The five large components are the bottom plate 10, the first sidewall 20 and the top cover 40 rotatably connected together, the second sidewall 30, the front door 50, and the rear plate 60.

The installation method includes the following steps:

causing a second sidewall 30 to form pre-installation with one side of a bottom plate 10;

causing a first sidewall 20 to form pre-installation with the other side of the bottom plate 10;

opening a top cover 40 rotatably connected to the first sidewall 20 and in a folded state to enable the top cover 40 to form a connection with the second sidewall 30;

connecting a front door 50 to one ends of the bottom plate 10, the top cover 40, the first sidewall 20, and the second sidewall 30; and

connecting a rear plate 60 to the other ends of the bottom plate 10, the top cover 40, the first sidewall 20, and the second sidewall 30.

When the bottom plate 10 and the first sidewall 20 are pre-installed, the bottom plate 10 is first placed at a relatively flat position, such as the ground. Then, an inner side of the first sidewall 20 is placed horizontally upwards on a tool cart. A height of the tool cart is set so that an outer side of the first sidewall 20 placed horizontally on the tool cart is slightly higher than the highest position of the bottom plate 10. The tool cart is pushed to cause the first sidewall 20 to approach the bottom plate 10 until the bottom end of the first sidewall 20 is above the slot 14 of the bottom plate 10. Next, the top end of the first sidewall 20 is lifted, so that the insertion plate 22 on the first sidewall 20 extends into the slot 14 from top to bottom, the tail end of the horizontal section 223 of the insertion plate 22 forms running fit with the abutment groove 16, and the first sidewall 20 is continuously turned until the first sidewall 20 is turned from horizontal to vertical, forming the state as shown in FIG. 9. During the turning, the insertion plate 22 squeezes the elastic bolt 12 exposed in the slot 14, so that the elastic bolt 12 contracts first and then extends into the insertion hole 220 of the insertion plate 22 to complete the fit with the board 22. So far, pre-installation of the first sidewall 20 and the bottom plate 10 has been completed. It may be understood that, prior to the pre-installation, as shown in FIG. 12, the decorative plates 27 on the top and the bottom of the first sidewall 20 can be removed first. In this case, the first sidewall 20 and the top cover 40 may be in a folded state.

A method for pre-installing the bottom plate 10 and the second sidewall 30 is the same as that the method for pre-installing the bottom plate 10 and the first sidewall 20. Details are not described. The first sidewall 20, the second sidewall 30, and the bottom plate 10 in the pre-installed state form insertion and may not fall over. Therefore, a single user can complete the pre-installation of the first sidewall 20, the second sidewall 30, and the bottom plate 10 in sequence without the assistance of a second person.

In the step of opening the top cover 40 rotatably connected to the first sidewall 20 and in a folded state to enable the top cover 40 to form a connection with the second sidewall 30, specifically, the top cover 40 may be rotated from bottom to top to cross and reach above the top end of the second sidewall 30 until the top cover 40 and the first sidewall 20 form an unfolded state. In the pre-installed state, both the first sidewall 20 and the second sidewall 30 have a certain degree of freedom of rotation and deflection relative to the bottom plate 10. Therefore, the top cover 40 has an enough avoiding space to rotate to the top end of the second sidewall 30 when unfolded. Then, the top cover 40 is reversely rotated from top to bottom and aligned with the second sidewall 30 to enable the insertion plate 34 on the second sidewall 30 to extend into the slot 44 of the top cover 40. In this process, the insertion plate 34 squeezes the elastic bolt 42 exposed in the slot 44, so that the elastic bolt 42 contracts first and then extends into the insertion hole 340 of the insertion plate 34 to complete the fit with the board 34, so as to complete the connection between the top cover 40 and the second sidewall 30.

After the pre-installation of the bottom plate 10, the first sidewall 20, the second sidewall 30, and the top cover 40, in order to further stabilize the connection between the first sidewall 20 and the bottom plate 10, as shown in FIG. 4 and FIG. 13, the first sidewall 20 and the bottom plate 10 can be further reinforced by threading a fastener through the fastening holes 1301 and 2101. After that, the decorative plate 27 removed previously can be reinstalled on the plate body 21 of the first sidewall 20. It may be understood that the second sidewall 30 and the bottom plate 10 as well as the second sidewall 30 and the top cover 40 may be operated similarly. Details are not described.

When the front door 50 is installed, an inner side of the front door 50 is placed horizontally upwards on the tool cart. The height of the tool cart is set to a height roughly flush with that of the leg 110 of the bottom plate 10. The front door 50 approaches the bottom plate 10 by using the tool cart, and then the top end of the front door 50 is lifted to make the front door 50 stand on the tool cart and aligned with one ends of the bottom plate 10, the top cover 40, the first sidewall 20, and the second sidewall 30. As shown in FIG. 26, the wrapping edge 537 and the outer edge 535 on the frame 53 of the front door 50 are separated, and then the outer edge 535 is rotated relative to the convex edge 531, so that the outer edge 535 exposes the wing edge 533. In this case, the wing edge 533 may be fixedly connected to the bottom plate 10, the top cover 40, the first sidewall 20, and the second sidewall 30 by means of the fastener 590.

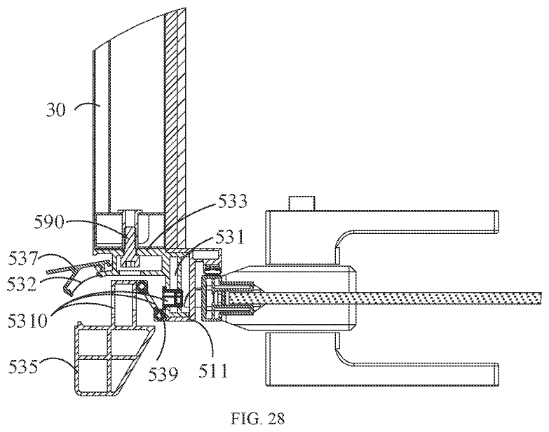

Then, as shown in FIG. 27 and FIG. 28, the outer edge 535 is reversely rotated relative to the convex edge 531. When the fastening holes 5310 on the rotary connecting portion 5351 of the outer edge 535, the adapter plate 539, and the convex edge 531 are aligned, the outer edge 535 and the convex edge 531 form a fixed connection by sequentially threading the fastener 59 through the fastening holes 5310.

Finally, the wrapping edge 537 is re-joined on the outer edge 535 to form the state as shown in FIG. 21.

The installation process of the rear plate 60 may be the same as that of the front door 50. Details are not described.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

What is claimed is:

1. A shielding device, comprising:
a bottom plate;
a first sidewall, a bottom end of the first sidewall being inserted into the bottom plate;
a second sidewall, a bottom end of the second sidewall being inserted into the bottom plate;
a top cover, the top cover having one side rotatably connected to the first sidewall and the other side inserted into the second sidewall;
a front door connected to respective one ends of the bottom plate, the first sidewall, the second sidewall, and the top cover; and
a rear plate connected to respective other ends of the bottom plate, the first sidewall, the second sidewall, and the top cover.

2. The shielding device according to claim 1, wherein the top cover is provided with an electronic device, and an outer surface of the first sidewall is provided with an input terminal, the input terminal being connected with the electronic device through a wire.

3. The shielding device according to claim 2, wherein the electronic device is one or more of a fan, a lamp, a speaker, and a camera.

4. The shielding device according to claim 2, wherein an inner surface of the first sidewall is provided with an output terminal, the output terminal being electrically connected to the input terminal.

5. The shielding device according to claim 1, wherein the first sidewall and the bottom plate are provided with an insertion plate, an elastic bolt, and a slot that fit one another, the insertion plate being provided with an insertion hole, the elastic bolt being at least partially exposed in the slot, and after the insertion plate extends into the slot, the elastic bolt fitting the insertion hole; or
the second sidewall and the bottom plate are provided with an insertion plate, an elastic bolt, and a slot that fit one another, the insertion plate being provided with an insertion hole, the elastic bolt being at least partially exposed in the slot, and after the insertion plate extends into the slot, the elastic bolt fitting the insertion hole; or
the second sidewall and the top cover are provided with an insertion plate, an elastic bolt, and a slot that fit one another, the insertion plate being provided with an insertion hole, the elastic bolt being at least partially exposed in the slot, and after the insertion plate extends into the slot, the elastic bolt fitting the insertion hole.

6. The shielding device according to claim 1, wherein the first sidewall or the second sidewall comprises a plate body and an insertion plate extending from the plate body, the insertion plate being provided with an insertion hole, and the bottom plate is provided with a slot and an elastic bolt, the elastic bolt being at least partially exposed in the slot, and after the insertion plate extends into the slot, the elastic bolt fitting the insertion hole.

7. The shielding device according to claim 6, wherein the insertion plate comprises a vertical section extending from the plate body and a horizontal section extending horizontally from the vertical section, a tail end of the horizontal section having a cambered configuration, the bottom plate is provided therein with an abutment groove and an installation groove, the slot runs through and is communicated with the abutment groove and the installation groove, a tail end of the horizontal section is in running fit with the abutment groove, and the elastic bolt is arranged in the installation groove.

8. The shielding device according to claim 7, wherein the insertion hole is at least partially formed in the vertical section.

9. The shielding device according to claim 7, wherein the elastic bolt comprises a bolt rod and an elastic member, the elastic member being connected between one end of the bolt rod and the bottom plate, the other end of the bolt rod being provided with a guide surface, the guide surface being at least partially exposed in the slot to be squeezed by the insertion plate to compress the elastic member.

10. The shielding device according to claim 9, wherein the elastic bolt further comprises a fixed handle and a limit handle, and the bottom plate is provided with a fixed groove and a limit groove, the fixed handle being fixedly arranged through the fixed groove and connected to the elastic member, and the limit handle being movably arranged through the limit groove and connected to the bolt rod.

11. The shielding device according to claim 10, wherein the bottom plate is provided with a hollow groove, and the slot, the limit groove, the fixed groove, and the hollow groove are successively spaced apart and are all communicated with the installation groove.

12. The shielding device according to claim 6, wherein the bottom plate comprises a base plate and shoulders arranged on two sides of the base plate, the shoulders being at least partially higher than the base plate, and the slot and the elastic bolt are arranged on parts of the shoulders higher than the base plate.

13. The shielding device according to claim 1, wherein the second sidewall comprises a plate body and an insertion plate extending from the plate body, the insertion plate being provided with an insertion hole, and the other side of the top cover is provided with a slot and an elastic bolt, the elastic bolt being at least partially exposed in the slot, and after the insertion plate extends into the slot, the elastic bolt fitting the insertion hole.

14. The shielding device according to claim 13, wherein the top cover is provided therein with an installation groove, the slot is communicated with the installation groove, and the elastic bolt is arranged in the installation groove.

15. The shielding device according to claim 14, wherein the elastic bolt comprises a bolt rod and an elastic member, the elastic member being connected between one end of the bolt rod and the top cover, the other end of the bolt rod being provided with a guide surface, the guide surface being at least partially exposed in the slot to be squeezed by the insertion plate to compress the elastic member.

16. The shielding device according to claim 15, wherein the elastic bolt further comprises a fixed handle and a limit handle, and the top cover is provided with a fixed groove and a limit groove, the fixed handle being fixedly arranged through the fixed groove and connected to the elastic member, and the limit handle being movably arranged through the limit groove and connected to the bolt rod.

17. The shielding device according to claim 16, wherein the top cover is provided with a hollow groove, and the slot, the limit groove, the fixed groove, and the hollow groove are successively spaced apart and are all communicated with the installation groove.

18. The shielding device according to claim 13, wherein the top cover comprises a cover plate and bending portions arranged on two sides of the cover plate and extending downwards, and the slot and the elastic bolt are arranged on the bending portions.

19. A shielding device, comprising:
a bottom plate;
a first sidewall, an outer surface of the first sidewall being provided with an input terminal, and the first sidewall being connected to the bottom plate;
a second sidewall, the second sidewall being connected to the bottom plate;
a top cover, the top cover having one side rotatably connected to the first sidewall and the other side connected to the second sidewall, the top cover being provided with an electronic device, the electronic device being connected to the input terminal through a wire;
a front door connected to respective one ends of the bottom plate, the first sidewall, the second sidewall, and the top cover; and
a rear plate connected to respective other ends of the bottom plate, the first sidewall, the second sidewall, and the top cover.

20. An installation method for a shielding device, the method comprising:
causing a second sidewall to form pre-installation with one side of a bottom plate;
causing a first sidewall to form pre-installation with the other side of the bottom plate;
opening a top cover rotatably connected to the first sidewall and in a folded state to enable the top cover to form a connection with the second sidewall;
connecting a front door to one ends of the bottom plate, the top cover, the first sidewall, and the second sidewall; and
connecting a rear plate to the other ends of the bottom plate, the top cover, the first sidewall, and the second sidewall.
